(19) United States
(12) Patent Application Publication
(10) Pub. No.: US 2007/0155267 A1
(43) Pub. Date: Jul. 5, 2007

(54) Disposable oil absorbent floor cover

(76) Inventor: Roland J.La Pierre, Honolulu, HI (US)

Correspondence Address: LITMAN LAW OFFICES, LTD., P.O. BOX 15035, CRYSTAL CITY STATION, ARLINGTON, VA, 22215, US

(21) Appl. No.: 11/648,789

(22) Filed: Jan. 3, 2007

Related U.S. Application Data
(60) Provisional application No. 60/755,077, filed on Jan. 3, 2006.

(51) Int. Cl. B32B 5/02; B32B 3/26

(52) U.S. Cl. 442/59; 442/396; 428/304.4

(57) ABSTRACT

The floor covering of the invention is made up of a first or support layer of a non-woven, cellulose web, with a dispersion of oil absorbing, polymer material powder/granules within the web. The bottom or non-skid layer comprises a mixture of latex and rubber. The top of the web has a closed-cell or closed-surface construction, constituting about 2% of the overall thickness of the covering, the top having a paper towel like consistency and feel. The floor covering is prepared using coil coating techniques of sequential coating and drying of the laminate surfaces.

### CROSS-REFERENCE TO RELATED APPLICATION

This application claims the benefit of U.S. Provisional Patent Application Ser. No. 60/755,077, filed Jan. 3, 2006.

### BACKGROUND OF THE INVENTION

1. Field of the Invention

The present invention relates to a disposable, protective covering for floors and other areas that are exposed to the spattering and splattering of oily droplets from cooking or other activities in the home or workplace. The protective covering comprises a non-woven, wood-pulp, fiber based cellulose web material, which is blended or fortified with a synthetic fiber, e.g., polypropylene, for strength as well as a more cloth-like feel for the user. An oil-absorbent polymer powder/granule, a styrene block copolymer (SAP) is evenly distributed and incorporated into the web. The top side of the web is a thin (approximately 2% of the total thickness of the covering), closed surface or closed cell material, which allows oil to pass through to the web, but retains the powder/granules within the web; it is not unlike a paper towel layer in feel and consistency. The top layer may be formed simultaneously with the cellulose web, or separately. The web material is covered on its bottom side with a closed, water-poof, anti-skid, plasticized rubber/latex surface (sheet or film), hot-melt glued on to the web.

2. Description of the Related Art

Oily floors, counters and work places are known to represent a serious physical hazard to occupants of homes and work places. They are, as well, unsightly and odoriferous and attract serious attention to their elimination or prevention from those people who are exposed to them. But spatterings and splatterings of oil are not easily removed from kitchen floors and work places, and the last residues of oil on floors are just as dangerous and unpleasant as the first drops. Oils, whether cooking oils or lubricant oils, are tenacious in their hold onto surfaces where they are spattered. Their removal often requires scrubbing of the substrate with a strong detergent, a chore that is at least inconvenient, if not hard work.

If the spattering of oils from cooking in the home, kitchen or the restaurant cannot be eliminated, the next best solution would be floor coverings that protect the floor. But the choices here are not without their own problems. The floor covering must be a powerful absorbent of oils so that spatteirngs that are deposited on or in the covering in the workplace are not transferred to the soles of occupant's shoes, for example, and thereby exaggerate the problem. Also, the reverse side of the covering should be a non-skid, non-slip layer to prevent accidental slipping or tripping when the covering is walked on; thus, the possibility of the covering itself becoming a menace is avoided. Furthermore, the covering should be useful as a wipe itself, by simply turning it over, and wiping up oil with the top, now bottom, paper towel-like surface. All of these requirements and properties of a flooring covering need to be realized in a floor covering that is also inexpensive and can be trashed after a brief usage. The combination of these requirements has not been found in the prior art. Specifically, most oil-absorbent non-wovens merely absorb oil in the manner of a sponge. They do not encapsulate or embed (or embody, perhaps) the oil they capture, as is the case with the present invention.

Thus a disposable oil absorbent floor cover solving the aforementioned problems is desired.

### SUMMARY OF THE INVENTION

The active form of the floor covering of the invention comprises the combination of a non-woven web, a dispersion of polymer material powder/granules within the non-woven web, a top, closed cell or surface layer, e.g., paper-towel-like in consistency and feel, and a non-skid layer. The non-woven web is a wood-pulp fiber based cellulose material, blended with a synthetic fiber, e.g., polypropylene, for added strength and a more cloth-like feel. The top layer, which may be formed simultaneously or separately with respect to the non-woven web, is about 2% of the overall thickness of the covering. It may be smooth, textured, wrinkled, and/or patterned. The material evenly distributed, dispersed and incorporated into the non-woven web is an oil-encapsulating, super-absorbent polymer powder/granule; it is a styrene block copolymer (SAP) designed for hydrocarbon absorption. A bottom layer is made up of a rubber/latex sheet which has its topside coated by a hot-melt glue, and it is rolled onto the web and pressed by a rolling pin to assure even and rather complete adherence of the latex layer to the web. This layer is impervious to oil absorbed from above, and into the web, and thus the floor is protected from contact with oils absorbed into the web.

One class of polymers, elastomers, has been found useful as a component of a non-skid mixture to removably adhere the substrate layer of the laminate of the invention to the floor. Elastomeric polymers are well known in the art and are useful as components in adhesive mixtures, among other things.

The disposable oil absorbent floor cover of the invention is manufactured by a simple, uncomplicated process. A non-woven relatively lofty, textured wood pulp-based, polymer blend web is a relatively open web of fibers, that is quite coarse, is closed on one side by a relatively thin (approximately 2% of the covering's overall thickness) closed cell or surface (e.g., a paper towel-like layer) that is formed simultaneously with or separately and then joined, by a method or methods known in the art. The absorbent polymer is deposited as powder/granules preferably onto and into the non-woven relatively lofty, textured wood pulp-based, polymer blend, non-woven material. Its coarse composition allows penetration of the powder/granules thereinto. The even deposition and penetration of the granules into the non-woven is enhanced by utilization of a vibrating table under a sprayer/spreader depositing the granules. The underside of the granule and non-woven web combination is provided with a non-skid surface that is hot-melt glued thereto by a rolling pin, and dried, preferably by hot air circulation. The drying operation is carried out at a drying station, and at a time and temperature sufficient to maintain the speed of the forming operation. Next, the coated and dried product is edge-sealed, then cut into desired dimensions with the cut elements further bsing edge-seamed or sealed, followed by folding or rolling, and final packaging. A typical cut size might be four feet by five feet, or three by five feet for floor coverings, and 12 by 12 inches, or maybe 12 by 16 inches for hand wipes. I any event, the dimensions and packaging of the end product may vary widely, and all are encompassed in the scope of the instant invention. As another example, both the floor covering and hand wipe embodiments of the invention might be wound in paper-towel like fashion on a core, with individual elements separated by seamed, perforated lines.

These and other features of the present invention will become readily apparent upon further review of the following specification and drawings.

### BRIEF DESCRIPTION OF THE DRAWINGS

FIG. 1 is a process diagram of the production of the oil absorbent product of the invention.

FIG. 2 is an enlarged-scale, section view of the invention, showing the web, the top, paper towel-like surface, the incorporated oil-absorbent powder/granules, and the non-skid, bottom surface.

FIG. 3 is a flow chart detailing the manufacture of the covering of the invention.

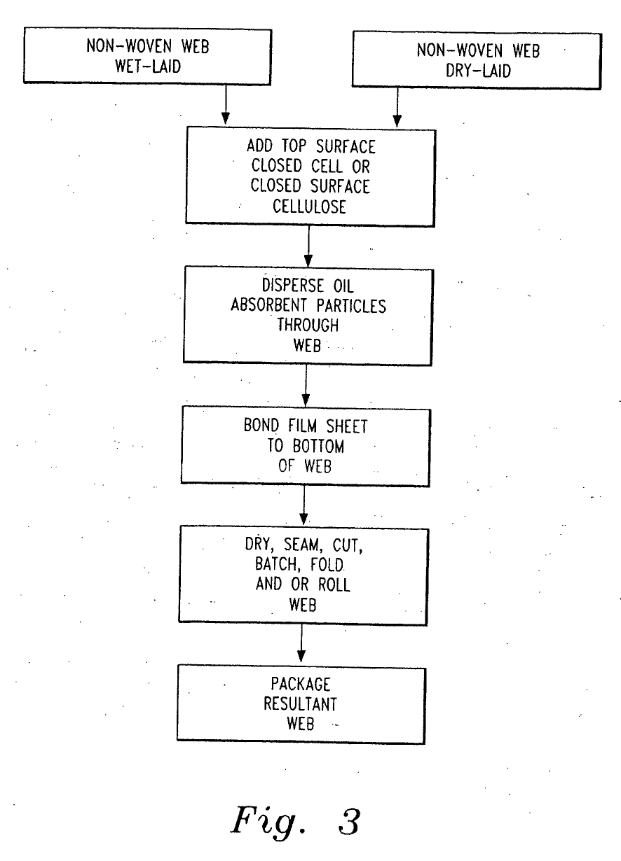

### DETAILED DESCRIPTION OF THE PREFERRED EMBODIMENT

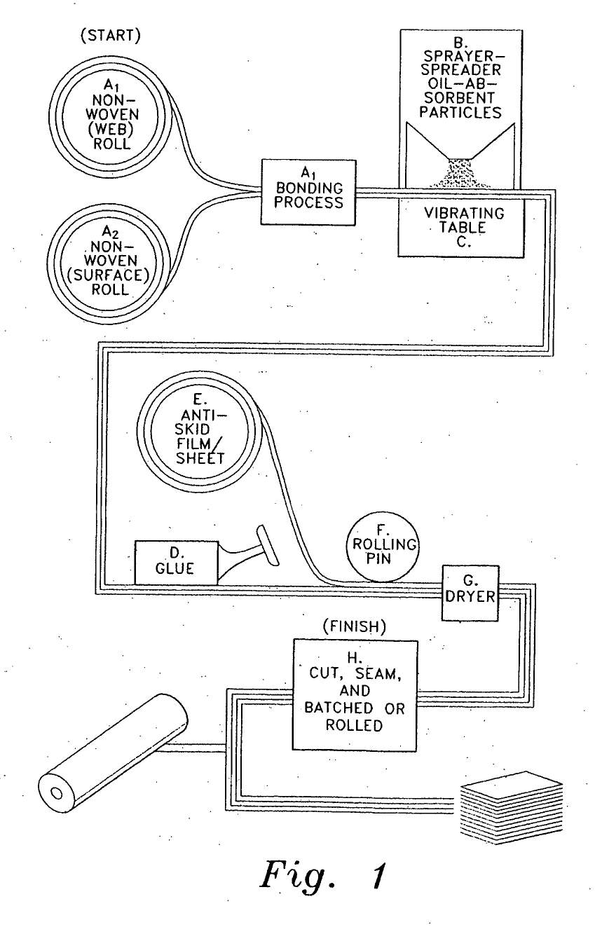

The laminate or floor covering of the instant invention is produced in a manner similar to established coil-impregnating and coating processes. The non-woven substrate is provided with a top layer that is closed-cell or closed-surface in construction. Of course, the non-woven itself may be formed by a wetlaid or drylaid process; such processes are well known in the art and need not be detailed here. This top surface may be formed simultaneously with creation of the non-woven web, or separately, and then bonded to the web by, for example, a needle-punching process. Referring to FIG. 1, a coil of the non-woven substrate web A₂ (which already has a layer of the closed cell top surface formed therewith, but on the bottom at this point in the process) is passed directly to a spreader station (B) where the oil-absorbent polymer granules are sprayed evenly onto the top surface of the material. A vibrating table (C) greatly assists in assuring the even distribution and dispersion of the powder/granules into the web. Alternatively, as shown in FIG. 1, the closed cell top surface is applied to a web A₁ at station A₁, before the station B. The point is the herein inventive process may be used with a wide variety of starter materials. A second coil (E) of a rubber/latex sheet is bottom-sprayed with a hot-melt glue sprayer (D), and applied to the web, which then passes beneath a rolling pin (F) to assure adequate bonding of the latex layer to the granule-impregnated web. A drying station (G) is provided to assure the bonding process(es) is completed satisfactorily. Finally, at the finishing station (H) the laminate is sealed and seamed at the edges, cut into desired lengths, batched, then folded or rolled, and packaged.

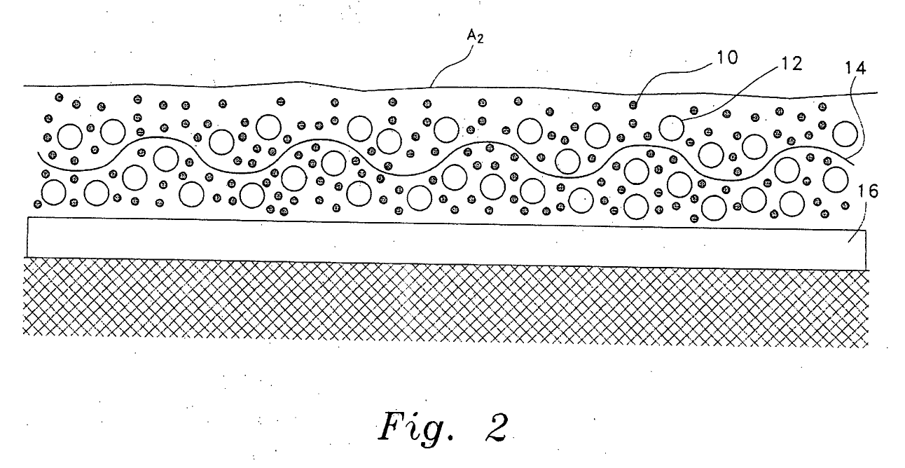

Referring to FIG. 2, a sectional view is presented of the finished laminate of the invention. Oil droplets (10) are encapsulated in the super absorbent material powder/granules (12) entrained in the cellulose fiber substrate (14). The granules have a diameter of from 400 to 4000 microns, preferably. The non-skid/non-slip backing (16) comprises the bottom coat of the laminate. Thus, absorbed oil passes easily through the top of the laminate, but not through the non-skid, oil-impervious bottom layer (16), which protects the floor from being soiled by any spilled or splattered oil. Also, when the covering is walked on, or one uses the covering to wipe up spattered oil, the oil does not penetrate through to the hands or feet of the user. Furthermore, the covering of the invention may be turned over and hand-held by a user to wipe up oil spilled or splattered onto the floor or other surface. The top layer A₂ acts as a paper towel would, and the captured oil is absorbed by the SAP granules and encapsulated therein, and thus no oil residue is left behind. The latex layer provides an easily gripped surface for the user and also assures that absorbed oil does not wick through and soil or coat the hands of the user with picked up oil.

The super-absorbent polymer granules are sold by Emerging Technologies, Inc., 1005 Norwalk Street, Greensboro, N.C., and is denominated as Liquiblock™ 1651.

The materials making up the covering of the invention are inexpensive enough so that the covering may be economically disposed of after use. Yet, the construction of the covering is efficient in catching and absorbing spattered oil(s), while also being useful to be turned over and employed as a wipe to pick up spilled or spattered oil. When used as a wipe, the covering may, of course, be cut into smaller, more easily handled sizes.

It is to be understood that the present invention is not limited to the embodiments described above, but encompasses any and all embodiments within the scope of the following claims.

I claim:

1. An oil absorbent floor cover laminate, comprising:
a non-woven, cellulose web;
a top layer of closed cell or closed surface, cellulose material;
a dispersion of oil-encapsulating super absorbent polymers powder/granules substantially evenly incorporated and distributed within the web; and
a bottom coating on the substrate comprising an anti-skid, anti-slip rubber/latex sheet or film, hot-melt glued onto the non-woven web.

2. The oil absorbent floor cover according to claim 1, the diameter of the oil encapsulating granules being on the order from 400 to 4000 microns.

3. The oil absorbent floor cover according to claim 1 wherein the bottom coating comprises a mixture of rubber and latex.

4. The oil absorbent floor cover according to claim 1, wherein said cellulose web is fortified with a synthetic fiber.

5. The oil absorbent floor cover according to claim 4, wherein said synthetic fiber is polypropylene.

6. The oil absorbent floor cover according to claim 1, wherein said top layer is dimensioned to have a total thickness on the order of 2% of the total floor cover laminate thickness.

7. The oil absorbent floor cover according to claim 1, wherein said top layer is fabricated to have the feel and consistency of a paper towel.

8. The oil absorbent floor cover according to claim 1, wherein each of said oil-encapsulating super absorbent polymers powder/granules comprise a styrene block polymer (SAP) designed for hydrocarbon absorption.

9. The oil absorbent floor cover according to claim 1, wherein the bottom coating comprises an elastomeric polymer.

10. An oil absorbent floor cover laminate, comprising:
a non-woven, cellulose web;
a top layer of closed cell or closed surface, cellulose material, fabricated to have a paper towel-like consistency and feel;
a dispersion of oil-encapsulating super absorbent polymers powder/granules substantially evenly incorporated and distributed within the web; and
a bottom coating on the substrate comprising an anti-skid, anti-slip mixture of rubber and latex sheet or film, hot-melt glued onto the non-woven web.

11. The oil absorbent floor cover according to claim 10, the diameter of the oil encapsulating granules being on the order from 400 to 4000 microns.

12. The oil absorbent floor cover according to claim 10, wherein said cellulose web is fortified with a synthetic fiber.

13. The oil absorbent floor cover according to claim 10, the diameter of the oil encapsulating granules being on the order from 400 to 4000 microns.

14. The oil absorbent floor cover according to claim 10, wherein said cellulose web is fortified with a synthetic fiber.

15. The oil absorbent floor cover according to claim 14, wherein said synthetic fiber is polypropylene.

16. The oil absorbent floor cover according to claim 10, wherein each of said oil-encapsulating super absorbent polymers powder/granules comprise a styrene block polymer (SAP) designed for hydrocarbon absorption.

17. The oil absorbent floor cover according to claim 10, wherein the bottom coating comprises an elastomeric polymer.

18. A method for the production of an oil absorbent floor cover comprising:
providing a cellulose, non-woven web with a top surface of closed-cell or closed surface cellulose material, the top surface having a paper-towel like consistency and feel;
dispersing through the cellulose, non-woven web, oil absorbent particles such that the particles are evenly dispersed and distributed throughout the non-woven web;
bonding the bottom side of the non-woven web with a solution of a mixture of plastic, rubber and latex to form a film or sheet; and
drying, seaming, cutting and batching, folding and/or rolling, and packaging the resultant web.

19. The method for the production of an oil absorbent floor cover according to claim 18, wherein said oil absorbent particles are each a styrene block copolymer (SAP) designed for hydrocarbon absorption, and having a diameter on the order of from 400 to 4000 microns.

20. The method for the production of an oil absorbent floor cover according to claim 18, wherein the cellulose, non-woven web is fortified with a synthetic fiber of polypropylene.
